(19) United States
(12) Patent Application Publication
(10) Pub. No.: US 2022/0245088 A1
(43) Pub. Date: Aug. 4, 2022

(54) CONNECTION METHOD FOR CONNECTING USB VIRTUAL COM DEVICE AND PROGRAM THEREFOR

(71) Applicant: NIDEC SANKYO CORPORATION, Nagano (JP)

(72) Inventor: Kyosuke KUBOTA, Nagano (JP)

(21) Appl. No.: 17/588,871

(22) Filed: Jan. 31, 2022

(30) Foreign Application Priority Data
Jan. 29, 2021 (JP) 2021-012961

(51) Int. Cl. G06F 13/42; G06F 13/40; G06F 13/38

(52) U.S. Cl. CPC G06F 13/4282; G06F 2213/0042; G06F 13/385; G06F 13/4068

(57) ABSTRACT

A connection method connecting an external device which is a USB virtual COM device with a host apparatus configured to execute an application program includes, when communication is going to be performed from the application program to the external device in a serial form, searching a setting information database of an operating system of the host apparatus with identification information as a USB device of the external device as a search key to acquire a port number corresponding to the external device, and starting the communication between the application program and the external device by using the port number having been acquired.

### CROSS REFERENCE TO RELATED APPLICATION

The present invention claims priority under 35 U.S.C. § 119 to Japanese Application No. 2021-012961 filed Jan. 29, 2021, the entire content of which is incorporated herein by reference.

### FIELD OF THE INVENTION

At least an embodiment of the present invention may relate to a connection method and a program for connecting an external device which is a USB virtual COM device with a host apparatus such as a host computer.

### BACKGROUND

Conventionally, in a case that an external device (for example, modem) operating by serial communication is connected with a host apparatus which is an information processing device such as a computer, an individual serial port (serial interface) for each purpose is provided in the host apparatus, and the serial port and the external device which is a target object to be connected are connected on a one-to-one basis. In a case that a plurality of individual serial ports is provided, respective ports are distinguished from each other by giving port numbers such as COM1, COM2 and the like. However, when ports or physical interfaces whose shapes or specifications are different are provided depending on their purposes, the number of the ports required to be physically mounted is increased in an information processing device and thus, the USB (Universal Serial Bus) standard which is a general-purpose interface standard has been proposed and connection of various external devices with a host apparatus through a USB port has become the mainstream. Access may be required from an application program premised to access an external device of an interface standard different from the USB standard to an external device which is physically connected with a USB port. In this case, a device driver for absorbing a difference of the interface standard is provided to access an external device from the application program. As a device driver for connecting an external device such as a modem which operates in serial communication, a common operating system (OS) is prepared with a CDC (Communication Device Class) device. In the following descriptions, an external device which is physically connected with a host apparatus through a USB port and is treated as being connected by serial communication from an application program in a host apparatus is referred to as a USB virtual COM device. A USB virtual COM (communication) device itself is a device which is physically connected with a USB port and thus, it is one type of USB device. Japanese Patent Laid-Open No. 2013-156877 (Patent Literature 1) discloses one example of an information processing device which controls a USB device by software corresponding an interface standard different from a USB standard.

A USB virtual COM device which is connected with a USB port of a host apparatus is identified by a port number from an application program of a host apparatus as if the virtual device is connected with an individual serial port. In a case that a plurality of USB virtual COM devices of different types is connected with a host apparatus, when an application program is going to communicate with a specific USB virtual COM device, a port number of the USB virtual COM device is required to be known on a side of the application program. As a method for checking a port number of a USB virtual COM device which is a target to be communicated, a method has been known in which a command suitable for a target USB virtual COM device is transmitted from a side of the application software while changing a port number from COM1, COM2, . . . in order, and the port number which replies an expected response for the command transmission is recognized as the port number for communicating with the target USB virtual COM device. However, in this method, a command is also transmitted to USB virtual COM devices other than a searching target USB virtual COM device (in other words, other USB virtual COM devices) and thus, communication to the other USB virtual COM devices may be interfered and malfunction of the other virtual COM devices may be caused.

### SUMMARY

In view of the problems described above, at least an embodiment of the present invention may advantageously provide a connection method and a program in which a desired external device which is a USB virtual COM device is searched without causing malfunction of other virtual COM devices and interference of communication and in which communication with the desired external device can be performed in a serial form from a side of an application program of a host apparatus.

According to at least an embodiment of the present invention, there may be provided a connection method in which an external device which is a USB virtual COM device is connected with a host apparatus configured to execute an application program. In the connection method, when communication is going to be performed from the application program to the external device in a serial form, a setting information database of an operating system of the host apparatus is searched with identification information as a USB device of the external device as a search key to acquire a port number corresponding to the external device, and the communication between the application program and the external device is started by using the port number having been acquired.

In the connection method in accordance with at least an embodiment of the present invention, a setting information database (for example, registry) of an operating system may be searched with identification information as a USB device of an external device as a search key to acquire a port number and thus, a command is not required to transmit to other USB virtual COM devices which are connected with a host apparatus and, therefore, malfunction of other USB virtual COM devices and interference of communication are not caused. When the port number is acquired, the application program is capable of communicating with the external device in a serial form.

In the connection method in accordance with at least an embodiment of the present invention, a vendor ID (identification) and a product ID as a USB device may be set as the identification information. When the vendor ID and the product ID are used as the identification information, it is not required to recognize a different external device of the same mode, and an operation on a side of the application program does not become complicated.

In the connection method in accordance with at least an embodiment of the present invention, in a case that a dynamic link library is provided between the application program and the operating system, when the dynamic link library receives a connection request to the external device from the application program, the dynamic link library may execute processing of searching the setting information database and acquiring the port number corresponding to the external device. According to this structure, when a model of an external device is changed or the like, its influence can be absorbed by the dynamic link library and thus, the application program is, for example, not required to update.

In the connection method in accordance with at least an embodiment of the present invention, when the external devices having the same identification information are registered in the setting information database in duplicate, each of the port numbers of the external devices in duplicate may be acquired, and then, connection may be sequentially checked by using each of the port numbers having been acquired and, after that, the communication may be started. In a case that an external device of the same model is replaced, an external device is connected to a different USB port, or the like, external devices having the same identification information may be registered in the setting information database in duplicate. In such a case, when connection is sequentially checked by using each of the acquired port numbers, the port number which is capable of actually using in communication with the external device can be known. In this case, a connection check is not performed on other USB virtual COM devices other than the target external device and thus, malfunction in the other USB virtual COM devices and interference of communication are not caused.

According to at least an embodiment of the present invention, there may be provided a program for a computer which is configured to execute an application program and has a USB port to be connected with an external device which is a USB virtual COM device. When communication is going to be performed from the application program to the external device in a serial form, the program causes the computer to execute processing of searching a setting information database of an operating system of a host apparatus with identification information as a USB device of the external device as a search key to acquire a port number corresponding to the external device, and processing of starting the communication between the application program and the external device by using the port number having been acquired.

According to the program in accordance with at least an embodiment of the present invention, a setting information database (for example, registry) of an operating system may be searched with identification information as a USB device of an external device as a search key to acquire a port number and thus, the port number can be acquired without transmitting a command to other USB virtual COM devices connected with the host apparatus which is a computer. Therefore, the port number can be acquired without causing malfunction of other USB virtual COM devices and interference of communication. When the port number is acquired, the application program is capable of communicating with the external device in a serial form.

In the program in accordance with at least an embodiment of the present invention, a vendor ID and a product ID as a USB device may be set as the identification information. When the vendor ID and the product ID are used as the identification information, it is not required to recognize a different external device of the same mode, and an operation on a side of the application program does not become complicated.

The program in accordance with at least an embodiment of the present invention may be a program of a dynamic link library which is provided between the application program and the operating system. The program causes the computer to execute processing of searching the setting information database when a connection request to the external device is received from the application program to acquire the port number corresponding to the external device. According to this structure, when a model of the external device is changed or the like, its influence can be absorbed by the dynamic link library and thus, the application program is, for example, not required to update.

In the program in accordance with at least an embodiment of the present invention, when the external devices having the same identification information are registered in the setting information database in duplicate, the program may cause the computer to execute processing of acquiring the port number of each of the external devices in duplicate and processing of sequentially checking connection by using each of the port numbers having been acquired. In a case that external devices having the same identification information are registered in the setting information database in duplicate, when connection is sequentially checked by using each of the acquired port numbers, the port number which is capable of being actually used in communication can be known. In this case, a connection check is not performed on other USB virtual COM devices other than the target external device and thus, malfunction in the other USB virtual COM devices and interference of communication are not caused.

### Effects of the Invention

According to the present invention, an external device which is a desired USB virtual COM device can be searched without causing malfunction of other virtual COM devices and interference of communication, and an application program of a host apparatus is capable of communicating with the desired external device from a side of the application program in a serial form.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is an explanatory block diagram showing connection between a host computer which is a host apparatus and an external device which is a USB virtual COM device.

FIG. 2 is a view showing an example of contents of a setting information file.

FIG. 3 is an explanatory flow chart showing a connection method in accordance with an embodiment of the present invention.

### DETAILED DESCRIPTION

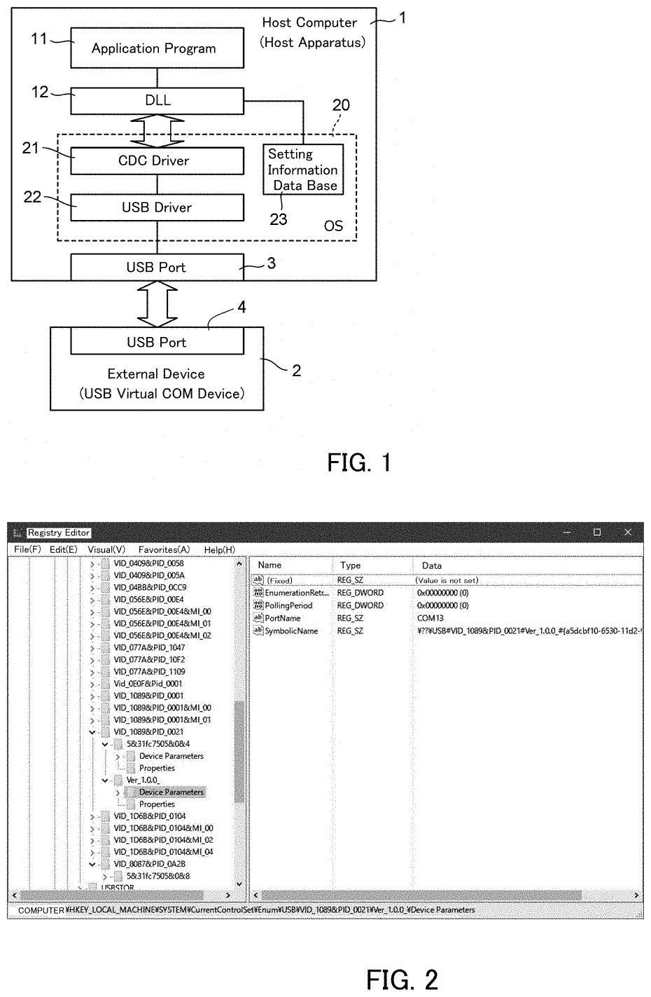

At least an embodiment of the present invention will be described below with reference to the accompanying drawings. This embodiment relates to connection of a USB virtual COM device with a host apparatus, and FIG. 1 shows connection between a host computer 1 which is a host apparatus and an external device 2 which is a USB virtual COM device.

A host computer 1 is, for example, structured of a general-purpose personal computer and is capable of executing an arbitrary application program 11. Especially, the host computer 1 includes a USB port 3 as an interface which is hardware. The host computer 1 is controlled by an operating system (OS) 20 which provides various services to the application program 11. In the host computer 1, the application program 11 is configured to request a service to the OS 20 through a dynamic link library (DLL) and receive a processing result from the OS 20. A USB CDC protocol is incorporated into the OS 20 and, therefore, the OS 20 includes a CDC driver 21 which is a device driver for a device operating by serial communication and a USB driver 22 provided between the CDC driver 21 and the USB port 3 to execute processing relating to a USB protocol. In addition, the OS 20 includes a setting information database 23 which collectively stores setting information regarding a system of the host computer 1, setting information regarding the application program 11, setting information regarding the DLL 12, setting information regarding the OS 20 and the like. The OS 20 is, for example, Microsoft (registered trademark) Windows (registered trademark) and, in this case, the setting information database 23 is a registry.

The external device 2 which is a USB virtual COM device is configured to be operated by serial data from the application program 11 and is physically detachably connected with the USB port 3 of the host apparatus 1 through a USB cable. The external device 2 includes a USB port 4 for connecting with the host computer 1 and is provided with an interface for receiving command data (instruction statements) from the host computer 1 and transmitting a response (reply) to the command to the host computer 1 through the USB port 4. The external device 2 includes a CPU (central processing unit), a ROM (read-only memory), a RAM (random-access memory) and the like, which are not shown, for operating and mechanically controlling according to the received command data. As an example, the external device 2 may be an IC (integrated circuit) card reader which is structured to read and write to an IC card. The external device 2 which is a USB device is assigned with a vendor (manufacturer) ID, a product ID and a serial number (individual number). The vendor ID, the product ID and the serial number are identification information capable of uniquely identifying a USB device. A type and specification of the external device 2 can be identified by the vendor ID and the product ID and, in addition, the external device 2 can be uniquely identified by using the serial number.

When the external device 2 is first connected with the USB port 3 based on a USB standard and a specification of the OS 20, the vendor ID, the product ID and the serial number are read out from the external device 2 and registered in the setting information database 23. The external device 2 is a USB virtual COM device and thus, a port number “COMn” (“n” is, for example, a natural number of 1 or more and 256 or less) is also assigned, and the port number “COMn” is also registered in the setting information database 23 in association with the vendor ID, the product ID and the serial number. The information regarding the external device 2 which is once registered in the setting information database 23 is left stored in the setting information database 23 after the external device 2 is detached from the host computer 1. In a case that the OS 20 is Microsoft (registered trademark) Windows (registered trademark), information regarding the external device 2 which is a USB virtual COM device is stored in the key HKEY_LOCAL_MACHINEYSYSTEM¥CurrentControlSet¥Enum¥USB in the registry which is the setting information database 23. FIG. 2 shows one example of information which is stored in the key HKEY_LOCAL_MACHINEYSYSTEM¥CurrentControlSet¥Enum¥USB of the registry.

FIG. 2 shows that an entry is provided for each combination of the vendor ID (VID) and the product ID (PID), and many such entries are recorded in the registry. Each of these entries indicates a USB device which has been connected with the host computer 1 before. For example, contents of the “Device Parameters” in the entry whose vendor ID (VID) is 1089 and product ID (PID) is 0021 (in other words, in the entry which is the “VID_1089&PID_0021” in the drawing) are shown in a region on the right side in FIG. 2. In this embodiment, the “COM 13” which is data recorded for a parameter whose name is the “PortName” indicates a port number assigned to the external device 2 which is a USB virtual COM device whose vendor ID is 1069 and product ID is 0021.

As described above, at a time when the external device 2 which is a USB virtual COM device is connected with the host computer 1, a port number is assigned to the external device 2 and is stored in the setting information database 23. However, the port number which is assigned is not automatically notified to the application program 11 and thus, the application program 11 is unable to know the port number assigned to the external device 2. The external device 2 is a USB virtual COM device and thus, the port number assigned to the external device 2 is required to use for transmitting and receiving data and commands to and from the external device 2 from a side of the application program 11. As a method for knowing a port number of a desired external device 2 from a side of the application program 11, there is a method that a command suitable for the target external device 2 is transmitted from a side of the application software 11 while changing a port number from COM1, COM2, . . . in order, and the port number which replies an expected response for the command transmission is recognized as the port number which is to be communicated with the target external device 2. However, in this method, a command is also transmitted to USB virtual COM devices other than the searching target external device 2 (in other words, other USB virtual COM devices) and thus, communication to the other USB virtual COM devices may be interfered and malfunction of the other virtual COM devices may be caused.

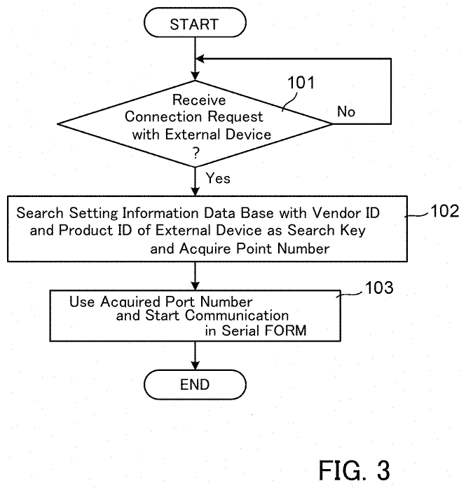

In a connection method in accordance with this embodiment, when the application program 2 is going to perform communication in a serial form to a desired external device 2, a port number of the desired external device 2 is searched without transmitting a command or the like to a device connected with the USB port 3, and the port number found by searching is used to start communication. FIG. 3 is an explanatory flow chart showing a connection method in accordance with an embodiment of the present invention.

Even if a port number of the desired external device 2 is not known, in a case that communication is going to be performed with a specific external device 2, at least its vendor ID and the product ID of the external device 2 are known. In the step 101, the DLL 12 waits for a connection request with the external device 2 from the application program 11. When the DLL 12 receives a connection request with the external device 2 from the application program 11, the DLL 12 searches the setting information database 23 within the OS 20 with the Vendor ID and the product ID of the external device 2 as a search key in the step 102 to acquire a port number. After that, the application program 11 or the DLL 12 starts communication in a serial form between the application program 11 and the external device 2 by using the acquired port number in the step 103. The vendor ID and the product ID of the external device 2 may be included in the connection request from the application program 11 to the DLL 12, or may be determined so that the DLL 12 having received the connection request refers to, for example, a table provided in the DLL 12 depending on a content of the connection request. When the vendor ID and the product ID are configured to determine in the DLL 12, only the DLL 12 is required to be updated and the application program 11 is not required to update in order to cope with an external device 2 which is a new model and in which at least its product ID is different.

As described above, in accordance with this embodiment, when the application program 11 which is installed in the host computer 1 is going to perform communication in a serial form with an external device 2 which is a USB virtual COM device connected with the USB port 3 of the host computer 1, a port number assigned to the external device 2 can be acquired without transmitting an actual command data. As a result, the application program 11 is capable of starting communication with a desired external device 2 without causing malfunction and interference of communication in other USB virtual COM devices connected with the host computer 1.

In the setting information database 23, a plurality of entries having the same vendor ID and the same product ID may be registered, in other words, the external devices 2 of the same model may be registered in duplicate. In such a case registered in duplicate, a plurality of external devices 2 of the same model may be actually simultaneously connected with the host computer 1. However, as described above, in principle, information having been registered in the setting information database 23 is not deleted and thus, the following cases may be included, for example, that an existing external device 2 is replaced with another external device 2 of the same model (in other words, with an external device 2 having a different serial number), and that the external device 2 is reconnected with a different USB port 3 of the host computer 1. In a case that external devices 2 of the same model are registered in duplicate in the setting information database 23, when searched as described above by using a vendor ID and a product ID, in many cases, a plurality of port numbers is acquired according to duplicate registrations. When a plurality of the port numbers is acquired, connection is sequentially checked, for example, by a method that a command is transmitted by using each of the acquired port numbers and the port number which has responded an expected response to the command transmission is determined as a port number which is to be used in communication. In this case, when the setting information database 23 is searched by using the vendor ID and the product ID as a search key, port numbers used in other USB virtual COM devices other than the target external device 2 are not obtained as search results and thus, even when connection is checked through command transmission, malfunction and interference of communication in the other USB virtual COM devices which are connected with the host computer 1 are not caused.

In the embodiment described above, the DLL 12 is provided between the application program 11 and the OS 20, and the DLL 12 searches the setting information data base 23. However, the application program 11 itself may search the setting information database 23 with the vendor ID and the product ID as a search key without providing the DLL 12 between the application program 11 and the OS 20. In this case, when the DLL 12 is provided, the DLL 12 is capable of flexibly coping with a situation, for example, that the external device 2 is changed into a new model, without performing update of the application program 11, and a load of communication processing by the application program 11 can be reduced.

In the host computer 1 shown in FIG. 1, each of the application program 11, the DLL 12 and the OS 20 is realized by a software program. Therefore, in this embodiment, a computer program for causing the above-mentioned processing to execute in the host computer 1 is also included. Such a program is read into the host computer 1 through an appropriate recording medium such as a CD-ROM or through a network.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A connection method connecting an external device which is a universal serial bus (USB) virtual communication (COM) device with a host apparatus which executes an application program, the connection method comprising:
when communication is going to be performed from the application program to the external device in a serial form,
searching a setting information database of an operating system of the host apparatus with identification information as a USB device of the external device as a search key to acquire a port number corresponding to the external device; and
starting the communication between the application program and the external device by using the port number having been acquired.

2. The connection method according to claim 1, wherein the identification information is a vendor identification (ID) and a product ID.

3. The connection method according to claim 1, wherein
a dynamic link library is provided between the application program and the operating system, and
when the dynamic link library receives a connection request to the external device from the application program, the dynamic link library executes processing of searching the setting information database and acquiring the port number corresponding to the external device.

4. The connection method according to claim 1, wherein
when the external device is provided in plural and external devices having same identification information are registered in the setting information database in duplicate, each of the port numbers of the external devices in duplicate is acquired, and then,
connection is sequentially checked by using each of the port numbers having been acquired, and
after that, the communication is started.

5. A program for a computer which executes an application program and comprises a USB port to be connected with an external device which is a USB virtual COM device,
wherein when communication is going to be performed from the application program to the external device in a serial form, the program causes the computer to execute:
processing of searching a setting information database of an operating system of a host apparatus with identification information as a USB device of the external device as a search key to acquire a port number corresponding to the external device; and
processing of starting the communication between the application program and the external device by using the port number having been acquired.

6. The program according to claim 5, wherein the identification information is a vendor ID and a product ID.

7. The program according to claim 5, wherein
the program is a program of a dynamic link library which is provided between the application program and the operating system, and
the program causes the computer to execute processing of searching the setting information database when a connection request to the external device is received from the application program to acquire the port number corresponding to the external device.

8. The program according to claim 5, wherein when the external device is provided in plural and external devices having same identification information are registered in the setting information database in duplicate, the program causes the computer to execute;
processing of acquiring the port number of each of the external devices in duplicate; and
processing of sequentially checking connection by using each of the port numbers having been acquired.

9. The connection method according to claim 2, wherein
a dynamic link library is provided between the application program and the operating system,
when the dynamic link library receives a connection request to the external device from the application program, the dynamic link library executes processing of searching the setting information database and acquiring the port number corresponding to the external device.

10. The connection method according to claim 9, wherein
when the external device is provided in plural and external devices having same identification information are registered in the setting information database in duplicate, each of the port numbers of the external devices in duplicate is acquired, and then,
connection is sequentially checked by using each of the port numbers having been acquired, and
after that, the communication is started.

11. The program according to claim 6, wherein
the program is a program of a dynamic link library which is provided between the application program and the operating system, and
the program causes the computer to execute processing of searching the setting information database when a connection request is received from the application program to the external device to acquire the port number corresponding to the external device.

12. The program according to claim 11, wherein
when the external device is provided in plural and external devices having same identification information are registered in the setting information database in duplicate, the program causes the computer to execute;
processing of acquiring the port number of each of the external devices in duplicate; and
processing of sequentially checking connection by using each of the port numbers having been acquired.
